(19) United States
(12) Patent Application Publication
(10) Pub. No.: US 2004/0066555 A1
(43) Pub. Date: Apr. 8, 2004

(54) Method and apparatus for generating stereoscopic images

(76) Inventor: Shinpei Nomura, Tokyo (JP)

Correspondence Address: DICKSTEIN SHAPIRO MORIN & OSHINSKY LLP, 2101 L STREET NW, WASHINGTON, DC, 20037-1526, US

(21) Appl. No.: 10/674,438

(22) Filed: Oct. 1, 2003

(30) Foreign Application Priority Data
Oct. 2, 2002 (JP) 2002-289559

(51) Int. Cl. G02B 27/22

(52) U.S. Cl. 359/462

(57) ABSTRACT

A method and an apparatus for generating stereoscopic images that can efficiently generate stereoscopic images that do not burden the observer's eyes are provided. The method includes the steps of converting object data made of polygons having 3D coordinates to parallax camera coordinate system data respectively with their origins at parallax cameras for right and left eyes having predetermined parallax angles; performing scaling using the converted parallax camera coordinate system data to compress coordinates of the parallax camera coordinate system data in the direction of the depth of a stereoscopic viewable range of a stereoscopic display device such that all the objects have their image formation positions within the stereoscopic viewable range; drawing the scaled parallax camera coordinate system data in a video memory; and displaying, on the stereoscopic display device, drawing data drawn in the video memory.

### BACKGROUND OF THE INVENTION

1. Field of the Invention

The present invention relates to a method and apparatus for generating stereoscopic images.

2. Description of the Related Arts

Among stereoscopic image display devices is that which realizes stereoscopic vision by allowing the observer's right and left eyes to perceive different images, thus causing parallax to take place. Such stereoscopic vision has heretofore been implemented by the lenticular system using lenticular lens (e.g., FIG. 6.18 in Document 1) , the parallax barrier system using parallax barrier (e.g., FIG. 6.15 of Document 1, Document 2) and others.

Document 1

“Fundamentals to 3D Picture” supervised by Takehiro Izumi published by Ohmsha, 1995.6.5 (pp.145-150)

Document 2

Japanese Patent No. 3096613

In the aforementioned parallax barrier system, a parallax barrier made of a number of fine slits is attached to limit the viewable direction for each pixel of the stereoscopic display device.

That is, images for right and left eyes that cause binocular parallax are set up in a single flat display such that they are perceived by corresponding eyes. Implementation of stereoscopic image display through such binocular parallax requires image data for right and left eyes to be created. Further, trinocular or more multinocular stereoscopic image display requires image data for a corresponding number of eyes to be created.

In a device that displays multinocular stereoscopic images, therefore, the numbers of times coordinate conversion processing is performed and a memory is accessed increase with the number of viewpoints. To resolve such an inconvenience, a method has been suggested in which images corresponding to a plurality of viewpoints are created by placing a virtual viewpoint in a space and displacing screen system objects based on the virtual viewpoint in screen coordinates according to binocular parallax (e.g., Document 3).

Document 3

Japanese Patent Application Laid-open No.2002-73003

In the case of stereoscopic display based on binocular parallax, there exists a predetermined range in which stereoscopic vision is possible with reference to the image display surface. Outside the stereoscopic viewable range, the observer cannot achieve stereoscopic vision, perceiving the image as being shaky. This will substantially burden the observer's eyes if the image is continuously observed.

This will be described further with reference to FIGS. 1A through 1F. FIG. 1A illustrates a view from above of a case in which images for left and right eyes are captured with parallax cameras CL and CR respectively for left and right eyes and having parallaxes when an object 1 serves as a viewpoint OP for an image consisting of an object 2 arranged on the front and an object 3 on the back of the object 1.

At this time, coordinate data SL for left eye and SR for right eye obtained respectively by the parallax cameras CL for left eye and CR for right eye are as shown in FIGS. 1B and 1C.

FIG. 1D illustrates image data SL and SR for left and right eyes corresponding respectively to the coordinate data SL and SR for left and right eyes. An observer 5 observes the image data SL and SR for left and right eyes as the data is displayed on a stereoscopic image display surface SC of a display device using the barrier system, the lenticular system or other system.

The observer 5 can perceive the displayed image data SL and SR for left and right eyes as stereoscopic image by sensuously combining the two pieces of data.

If the objects 2 and 3 form their images at or more than a predetermined distance (a range 4 that gives stereoscopic perception) from the stereoscopic image display surface SC of the display device, the images of the objects 2 and 3 observed by the left and right eyes of the observer 5 undergo considerable displacements of corresponding points, (2-1, 2-2) (3-1, 3-2), thus resulting in being perceived as shaky and making stereoscopic vision impossible. In the example shown in FIG. 1, the image with only the object 1 is stereoscopically viewable.

A critical visual factor for achieving stereoscopic vision relates to binocular parallax. The fact that right and left eyes are apart prevents the same image from being perceived by both eyes when a certain object is looked at, causing a discrepancy at a position more distant than the gazing point. In the presence of discrepancy between images perceived by two eyes, the images are generally viewed as a double image. However, if binocular parallax is equal to or smaller than a certain level, the images are merged, resulting in being perceived as a 3D image.

FIG. 2 illustrates an explanatory drawing thereof. In FIG. 2, we let an observation distance from the observer 5 to the display surface SC be Lreal, an eye-to-eye distance of the observer 5 be E, a limit distance from the display surface SC to the forward stereoscopic viewable range 4 be n, a limit distance from the display surface SC to the backward stereoscopic viewable range 4 be f, a difference in displacement between corresponding points due to parallax be D (a difference indisplacement due to parallax that gives forward stereoscopic viewable image formation limit be Dₙ and a difference in displacement due to parallax that gives backward stereoscopic viewable image formation limit be D_{f}).

For most observers, a physiological limit distance for binocular fusion is roughly 0.03 times the observation distance Lᵣₑₐₗ. For instance, if the observation distance Lᵣₑₐₗ=60 cm, it becomes difficult to stereoscopically view the corresponding point at a distance of 1.8 cm or more in the difference in displacement Dₙ or D_{f}.

In this case, if we let the observer's eye-to-eye distance E be 6.5 cm, the forward image formation limit n is located n≈13.0 cm from the display surface SC because of the relation n(60−n)=1.8/6.5. On the other hand, the backward image formation limit f is located f≈23.0 cm from the display surface SC because of the relation f/(60+f)=1.8/6.5. Thus, stereoscopic vision is difficult outside the stereoscopic viewable range 4 relative to the eye-to-eye distance E.

Such a range in which stereoscopic vision is not possible is described neither in the above Document 1 nor in the Documents 2 and 3. Therefore, there exist no descriptions suggesting techniques for addressing such a range.

### SUMMARY OF THE INVENTION

In view of the foregoing, it is an object of the present invention to provide a method and apparatus for generating stereoscopic images that can efficiently generate stereoscopic images that do not burden the observer's eyes.

It is another object of the present invention to provide a method and apparatus for generating stereoscopic images for making the stereoscopic images more highlighted on the screen by displaying, from a different viewpoint, stereoscopic and planar images in a mixture.

In order to attain the above objects, a method and apparatus for generating stereoscopic images according to the present invention include, as a first aspect, converting, of objects made of polygons having 3D coordinates, object data to be displayed in a planar view to reference camera coordinate system data with its origin at a reference camera and converting object data to be displayed in a stereoscopic view to parallax camera coordinate system data for right and left eyes respectively with their origins at parallax cameras for right and left eyes having predetermined parallax angles; drawing the reference camera coordinate system object data and the parallax camera coordinate system object data for right eye as image data for right eye in a video memory; drawing the reference camera coordinate system object data and the parallax camera coordinate system object data for left eye as image data for left eye in the video memory; and synthesizing the image data for right and left eyes drawn in the video memory and displaying, on a stereoscopic display device, images mixing stereoscopic and planar objects.

As a second aspect, to attain the above objects, in the method and apparatus for generating stereoscopic images according to the first aspect of the present invention, the objects to be displayed in a planar view are objects having their image formation positions outside a stereoscopic viewable range of the stereoscopic display device in a 3D coordinate space.

In order to attain the above objects, a method and apparatus for generating stereoscopic images according to the present invention comprise, as a third aspect, converting object data made of polygons having 3D coordinates to parallax camera coordinate system data respectively with their origins at parallax cameras for right and left eyes having predetermined parallax angles; performing scaling using the converted parallax camera coordinate system data to compress coordinates of the parallax camera coordinate system data in the direction of the depth of a stereoscopic viewable range of a stereoscopic display device such that all the objects have their image formation positions within the stereoscopic viewable range; drawing the scaled parallax camera coordinate system data in a video memory; and displaying, on the stereoscopic display device, drawing data drawn in the video memory.

In order to attain the above objects, a method and apparatus for generating stereoscopic images according to the present invention comprise, as a fourth aspect, converting object data made of polygons having 3D coordinates to parallax camera coordinate system data respectively with their origins at parallax cameras for right and left eyes having parallax angles; narrowing the parallax angles during conversion to the parallax camera coordinate system data such that all objects of the parallax camera coordinate system data to be converted have their image formation positions within a stereoscopic viewable range of a stereoscopic display device; and displaying, on the stereoscopic display device, the converted parallax camera coordinate system data at the narrowed parallax angles.

In order to attain the above objects, a method and apparatus for generating stereoscopic images according to the present invention comprises, as a fifth aspect, converting object data made of polygons having 3D coordinates to reference camera coordinate system data with its origin at a reference camera; converting, of object data converted to the reference camera coordinate system data, object data to be displayed in a stereoscopic view to parallax camera coordinate system object data respectively with their origins at parallax cameras for right and left eyes having predetermined parallax angles; drawing the reference camera coordinate system object data and the parallax camera coordinate system object data for right eye as image data for right eye in a video memory; drawing the reference camera coordinate system object data and the parallax camera coordinate system object data for left eye as image data for left eye in the video memory; and

synthesizing the image data for right and left eyes drawn in the video memory and displaying, on a stereoscopic display device, images mixing stereoscopic and planar objects.

As a sixth aspect, to attain the above objects, in the method and apparatus for generating stereoscopic images according to the fifth aspect of the present invention, the objects to be displayed in a planar view are objects having their image formation positions outside a stereoscopic viewable range of the stereoscopic display device in a 3D coordinate space.

In order to attain the above objects, a method and apparatus for generating stereoscopic images according to the present invention comprises, as a seventh aspect, converting object data made of polygons having 3D coordinates to reference camera coordinate system data with its origin at a reference camera; generating, from the reference camera coordinate system data, parallax camera coordinate system data respectively with their origins at parallax cameras for right and left eyes having parallax angles; performing compression scaling during generation of the parallax camera coordinate system data such that all objects have their image formation positions within a stereoscopic viewable range of a stereoscopic display device; drawing the parallax camera coordinate system data for right and left eyes in a video memory; and synthesizing the image data for right and left eyes drawn in the video memory and displaying the data on the stereoscopic display device.

In order to attain the above objects, a method and apparatus for generating stereoscopic images according to the present invention comprises, as an eighth aspect, converting object data made of polygons having 3D coordinates to reference camera coordinate system data with its origin at a reference camera; converting the reference camera coordinate system data to parallax camera coordinate system data respectively with their origins at parallax cameras for right and left eyes having parallax angles; narrowing the parallax angles during conversion to the parallax camera coordinate system data such that all objects of the parallax camera coordinate system data to be converted have their image formation positions within a stereoscopic viewable range of a stereoscopic display device; and displaying, on the stereoscopic display device, the converted parallax camera coordinate system data at the narrowed parallax angles.

As a ninth aspect, to attain the above objects, in the method and apparatus for generating stereoscopic images according to any one of the first to eighth aspects of the present invention, the parallax angles of the parallax cameras are adjustable in real time by operations of an observer.

As a tenth aspect, to attain the above objects, in the method and apparatus for generating stereoscopic images according to the ninth aspect of the present invention, the parallax angles are continuously and gradually varied as a result of the adjustment by operations of the observer.

### BRIEF DESCRIPTION OF THE DRAWINGS

The above and other objects, aspects, features and advantages of the present invention will become more apparent from the following detailed description when taken in conjunction with the accompanying drawings, in which:

FIGS. 1A through 1F illustrate a conventional example;

FIG. 2 illustrates a stereoscopic viewable range 4 shown in FIGS. 1;

FIGS. 3A through 3F illustrate a first solution principle of the present invention;

FIGS. 4A through 4C illustrate another solution principle of the present invention;

FIGS. 5A through 5F illustrate a method according to a third solution principle of the present invention;

FIGS. 6A and 6B illustrate a general view of a configuration example for a gaming apparatus as an apparatus for generating stereoscopic images to which a method for generating stereoscopic images according to a solution principle of the present invention is applied;

FIG. 7 illustrates a block diagram showing a configuration of the apparatus for generating stereoscopic images to which the method for generating stereoscopic images according to the solution principle of the present invention is applied;

FIG. 8 illustrates a flowchart showing processing of the geometry unit 14 that provides the features of the method for generating stereoscopic images of the present invention;

FIGS. 9A through 9D illustrate processing steps corresponding to FIG. 8;

FIGS. 10A through 10C illustrate a method for converting reference camera coordinate system data to parallax camera coordinate system data to generate parallax images;

FIG. 11 illustrates a configuration example for a parallax conversion unit;

FIG. 12 illustrates a working example for configuring the parallax conversion unit with an operator;

FIG. 13 illustrates a working example for speeding up processing of the parallax conversion unit;

FIGS. 14A through 14C illustrate explanatory drawings describing a difference in displacement D due to parallax;

FIGS. 15A and 15B illustrate explanatory drawings describing changing of applied parallax data by a parallax adjustment unit 103;

FIG. 16 illustrates an example of processing operations in FIG. 7 corresponding to FIG. 15;

FIG. 17 illustrates a working example in which only objects in the air are viewed stereoscopically while an object on the ground is viewed planarly;

FIG. 18 illustrates a plan view corresponding to FIG. 17;

FIG. 19 illustrates a stereoscopic/planar image mixture drawing routine flow;

FIG. 20 illustrates a drawing routine flow for right (left) eye;

FIGS. 21A through 21C illustrate explanatory drawings describing a synthesized image for stereoscopic viewing in the working example shown in FIG. 17; and

FIGS. 22A through 22E illustrate the process of displaying drawn images for left and right eyes, described in FIGS. 17 to 21, on a stereoscopic display device.

### DESCRIPTION OF THE PREFERRED EMBODIMENTS

While embodiments of the present invention will be described below with reference to the accompanying drawings, the solution principles of the present invention will be described first.

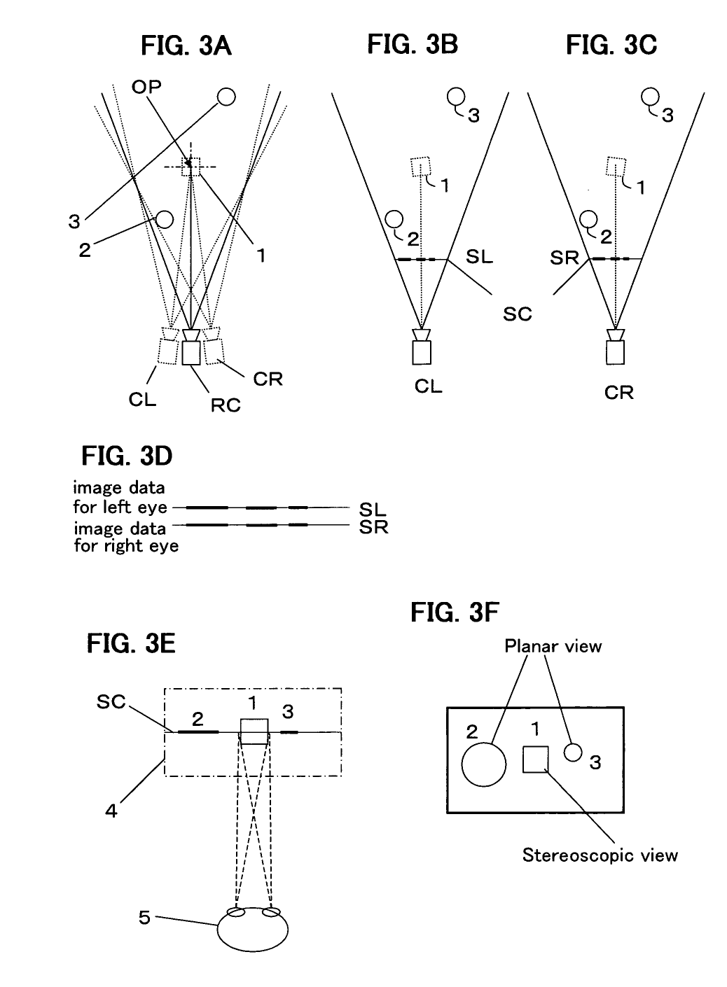

FIGS. 3A through 3C illustrate explanatory drawings of a first solution principle of the present invention. FIG. 3A illustrates a top view showing the objects 2 and 3 each made of a plurality of polygons that are arranged respectively on the front and back of the object 1, that is similarly made of a plurality of polygons, in a 3D virtual space.

The figure illustrates a top view showing a case in which, when the object 1 is the viewpoint OP, images for left and right eyes are captured with the parallax cameras CL and CR respectively for left and right eyes, each of which has a line of sight at a predetermined angle relative to a line of sight from a reference camera RC toward the viewpoint OP.

We now consider a case in which the objects 2 and 3 are displayed in a planar view while the object 1 is displayed in a stereoscopic view. In this case, coordinate data of the objects 2 and 3 is obtained from the reference camera RC.

On the other hand, coordinate data of the object 1 for left eye is obtained from the parallax camera CL for left eye. Similarly, coordinate data of the object 1 for right eye is obtained from the parallax camera CR for right eye.

The coordinate data of the objects 2 and 3 obtained from the reference camera RC is shared as coordinate data for left and right eyes. When the objects 1, 2 and 3 are positioned as shown in FIG. 3A, therefore, coordinate data for left eye is as shown in FIG. 3B while that for right eye as shown in FIG. 3C.

The image data SL and SR for left and right eyes, obtained respectively from the coordinate data for left and right eyes, is as shown in FIG. 3D.

The image data SL and SR for left and right eyes is displayed on a common stereoscopic image display device. FIG. 3E illustrates a relation diagram viewed from above at this time while FIG. 3E a relation diagram viewed from the observer 5.

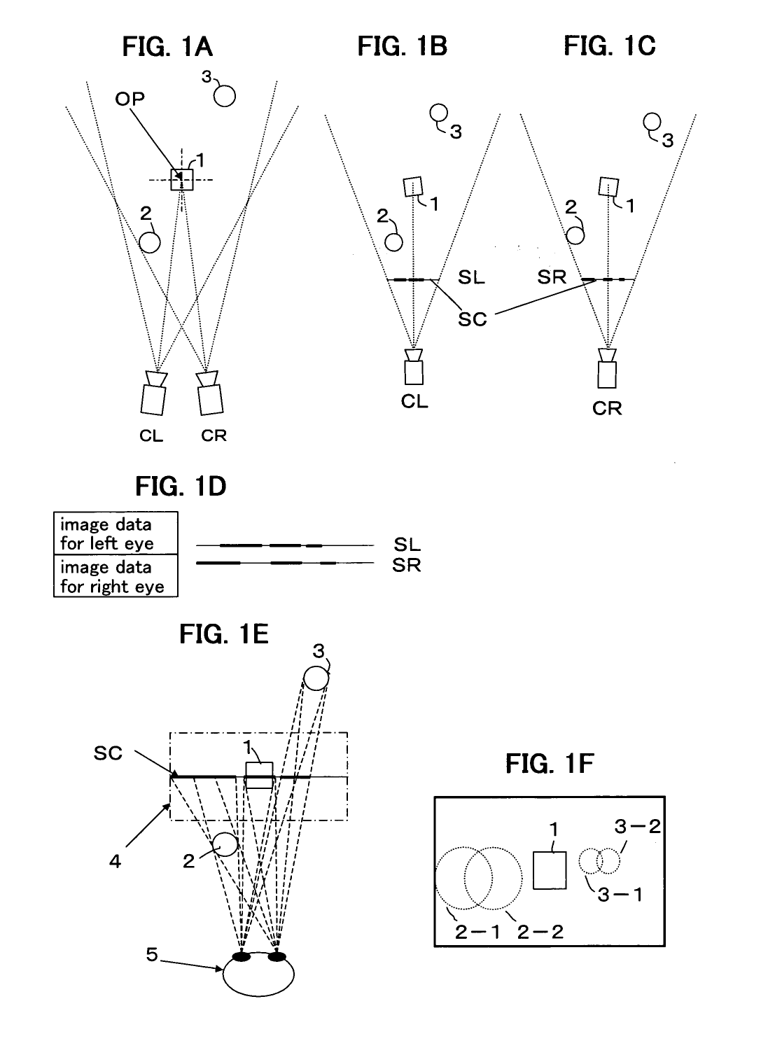

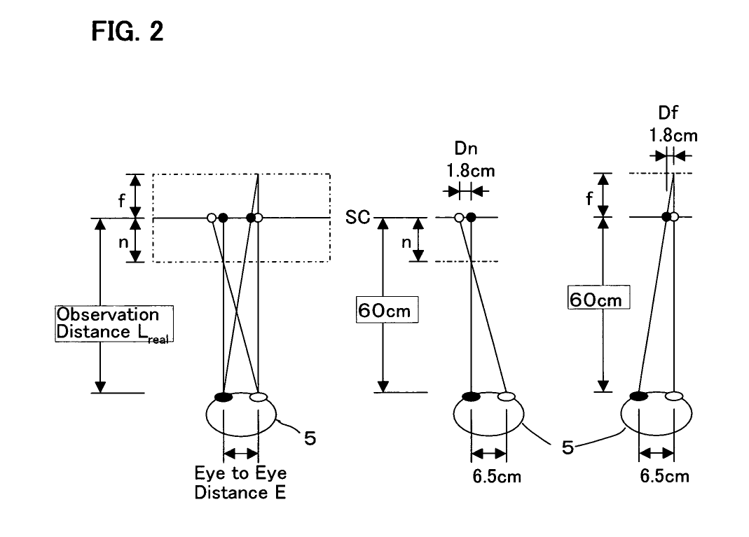

In FIGS. 3E and 3F, the objects 2 and 3 are displayed as planar images on the display surface SC of the stereoscopic display device while the object 1 is displayed as a stereoscopic image. This results in the image of the object 1 appearing more highlighted than the images of the objects 2 and 3. At the same time, as is apparent from FIG. 3F, it is possible to prevent the displayed images 2 and 3 from appearing shaky as compared with FIG. 1F by displaying the objects 2 and 3 as planar images, even if the coordinate positions of the objects 2 and 3 are outside the stereoscopic viewable range 4.

If the solution principle is applied, for example, to game program images, the peripheral objects 2 and 3 are displayed non-three-dimensionally as opposed to the central object 1. However, since the main object 1 at the center can be stereoscopically viewed, game players can observe the powerful object 1 image on the whole while playing the game.

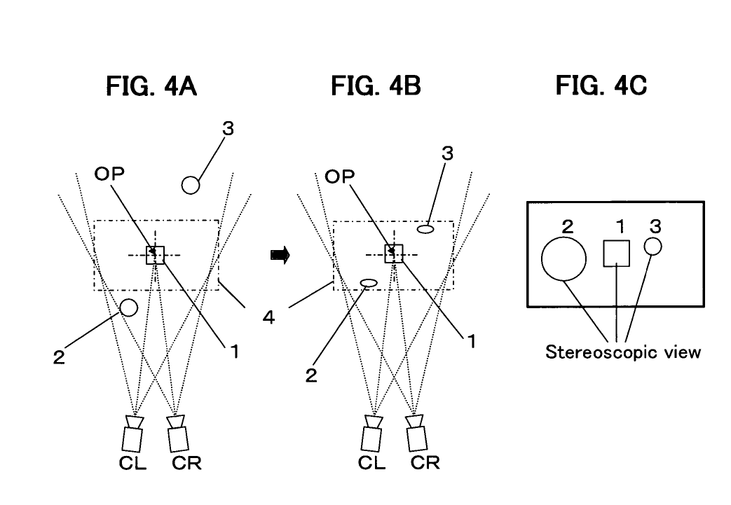

FIGS. 4A through 4C illustrate a second solution principle of the present invention. FIG. 4A illustrates a top view showing a case in which, when the object 1 is the viewpoint OP, the object 1 placed in a virtual space, with the objects 2 and 3 arranged respectively on the front and back of the object 1, is captured with the parallax cameras CL and CR respectively for left and right eyes.

At this time, the objects 2 and 3 are outside the range 4 that gives three-dimensional appearance on the display device. In such a case, the second solution principle scales all objects to compress the coordinate in the direction of the depth of the stereoscopic viewable range 4, that is, the coordinate along the Z axis of the virtual space such that the images of the objects 2 and 3 are inside the stereoscopic viewable range 4 that gives three-dimensional appearance on the display device (refer to FIG. 4B). This allows for the objects 1, 2 and 3 to be observed without changing the relative positional relationship between the objects, as shown in FIG. 4C.

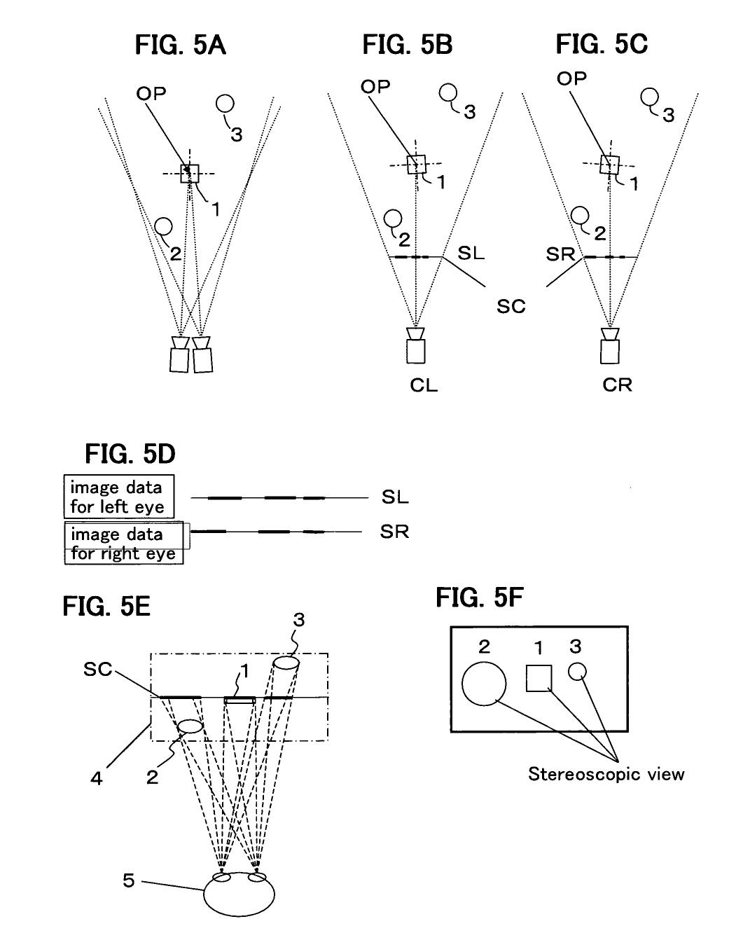

However, when the objects in the virtual space are scaled, it is necessary to recalculate vertex positions of the polygons constituting the objects, thus resulting in increased amount of processing. In this respect, a third solution principle shown in FIGS. 5A through 5F is preferred.

FIG. 5A illustrates a top view showing a case in which, when the object 1 is the viewpoint OP, an image of the object 1, with the objects 2 and 3 arranged respectively on the front and back of the object 1, is captured with the parallax cameras CL and CR for left and right eyes having parallax angles.

The image data SL and SR for left and right eyes, obtained at this time respectively from the parallax cameras CL and CR for left and right eyes for the projection surface SC, is as shown in FIGS. 5B and 5C. Further, FIG. 5D illustrates images for left and right eyes generated from the image data SL and SR for left and right eyes.

The feature of the solution principle shown in FIG. 5E is that the parallax angle between the parallax cameras CL and CR for left and right eyes is small enough such that the objects 2 and 3 fall within the stereoscopic viewable range 4.

This reduces the margin of displacement as a result of parallax, thus reducing the distance from the image display surface SC to the image formation positions of the objects 2 and 3 and thereby allowing for the objects 2 and 3 to be placed inside the stereoscopic viewable range 4. Therefore, the solutionprincipleprovides the same effect as that discussed above in which the objects are scaled.

That is, the objects 1, 2 and 3 can be stereoscopically viewed without changing the relative positional relationship between the objects in the scene as a whole.

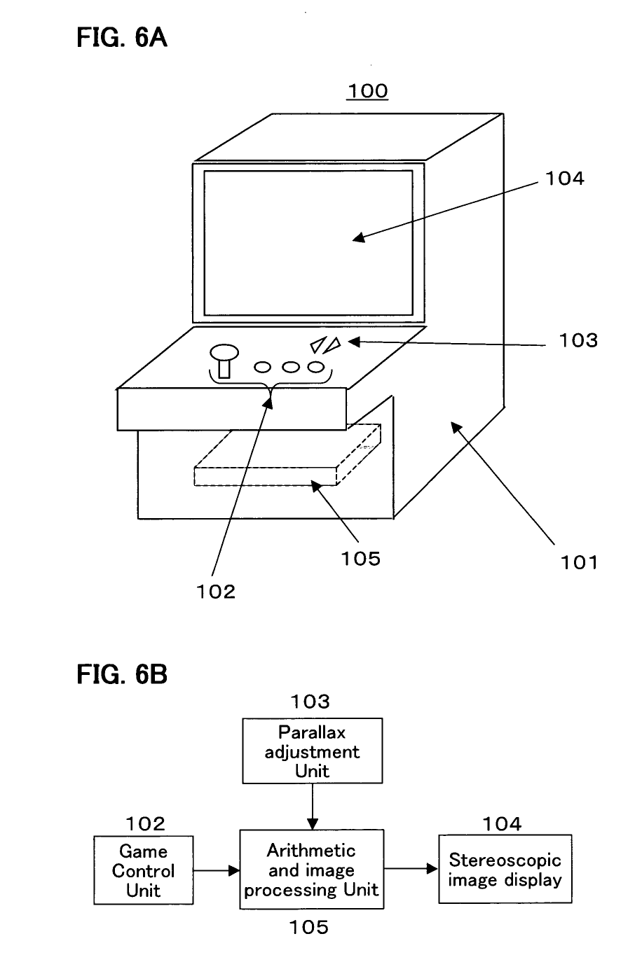

FIGS. 6A and 6B illustrate a configuration example for a gaming apparatus 100 as an apparatus for generating stereoscopic images to which the method for generating stereoscopic images according to the aforementioned solution principle of the present invention is applied. FIG. 6A illustrates a general view of the configuration example for the gaming apparatus 100 while FIG. 6B a hardware block diagram.

The gaming apparatus 100 is provided with an operating console projecting to the front of an enclosure 101, and the operating console is provided with a game control unit 102, a parallax adjustment unit 103 and further a stereoscopic image display unit 104 that faces forward. Further, the gaming apparatus 100 incorporates an arithmetic and image processing unit 105.

The arithmetic and image processing unit 105 generates stereoscopic image data and displays the data on the stereoscopic image display unit 104 according to information input from the game control unit 102 and the parallax adjustment unit 103.

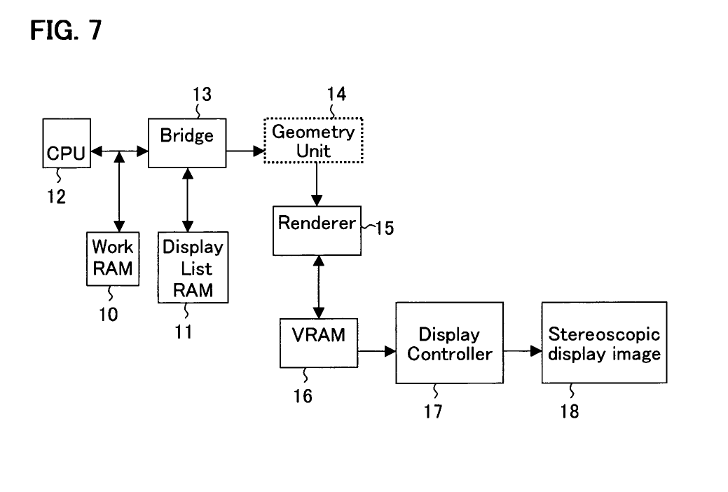

FIG. 7 illustrates a block diagram showing a configuration example for the arithmetic and image processing unit 105 that is provided inside the enclosure 101 of the gaming device 100 and the method for generating stereoscopic images according to the solution principle of the present invention is applied.

In FIG. 7, a work memory 10 stores an application program while a display list memory 11 stores a display list—a program that handles setup, arithmetic and polygon drawing procedure to create models.

The application program and the display list are read from the work memory 10 for program processing in a CPU 12. The program processing results by the CPU 12 are sent to a geometry unit 14 via a bridge 13—an interface.

Based on program processing results by the CPU 12, the geometry unit 14 converts model data made of a plurality of polygons defined by world coordinate data to camera coordinate system data with its origin at a camera position and further performs processing such as clipping, culling, brightness calculation, texture coordinate arithmetic and perspective projection transform. In converting model data defined by world coordinate data to camera coordinates, in particular, parallax conversion—a feature of the present invention—is performed after conversion to reference camera coordinate system data, as a result of which parallax camera coordinate system data for right and left eyes is obtained.

Next, a renderer (rendering unit) 15 reads texture data from a video RAM 16 that serves both as a texture memory and a frame buffer and fills the polygons based on the texture coordinate arithmetic results.

Image data with filled texture data is stored again in the video RAM 16, with reference camera coordinate system data and parallax camera coordinate system data for right eye used as image data for right eye and reference camera coordinate system data and parallax camera coordinate system data for left eye used as image data for left eye. Then, a display controller 17 synthesizes image data for right and left eyes read from the video RAM 16, and the synthesized image data is sent to a stereoscopic display device 18 for display of a stereoscopic image.

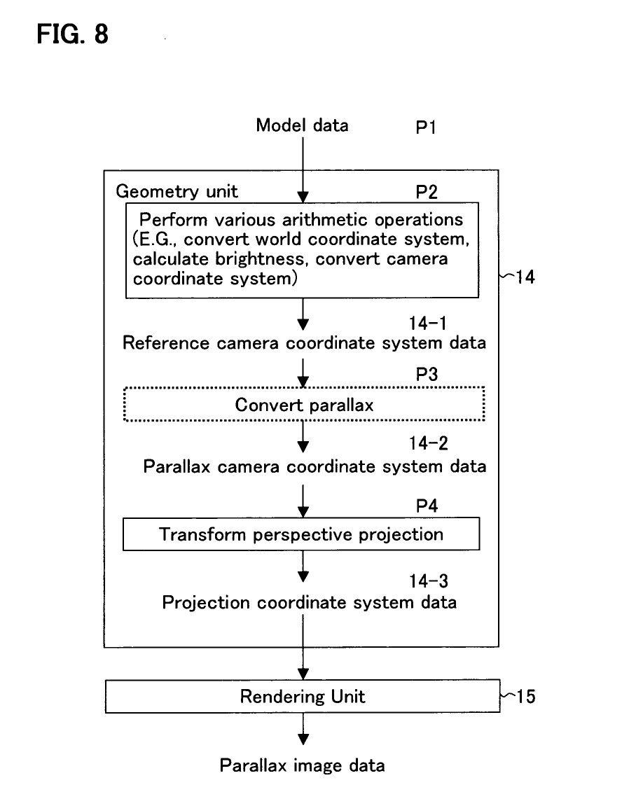

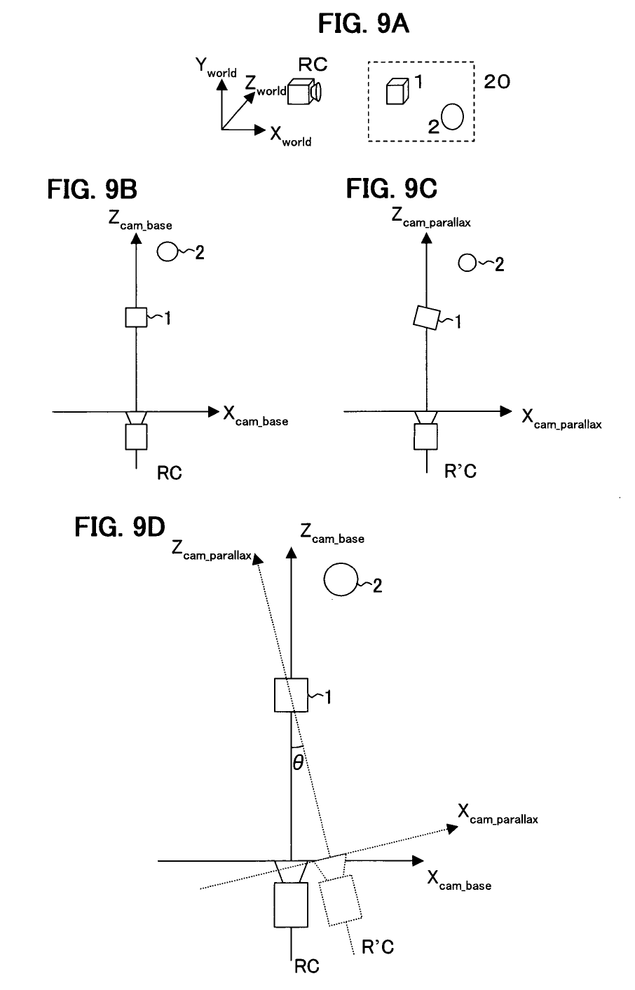

FIG. 8 illustrates a flowchart showing processing of the geometry unit 14 that provides the features of the method for generating stereoscopic images of the present invention. FIG. 9 illustrate processing steps corresponding to FIG. 8.

Note that processing may be performed on a polygon-by-polygon basis or vertex-by-vertex basis in FIG. 8.

First, model data 20 having models 1 and 2 and stored in work memory 11 is, for example, read into the geometry unit 14 via the bridge 13 under the control of the CPU 14 in FIG. 7 (processing step P1).

The model data has local coordinates. Therefore, the local coordinate system model data is converted by the geometry unit 14 to the world coordinate system model data 20 as shown in FIG. 9A and is further subjected to coordinate conversion from world coordinate system data to reference camera coordinate system data with its origin at the reference camera RC (processing step P2).

Model data 14-1 converted to reference camera coordinate system data through coordinate conversion is then subjected to parallax conversion (processing step P3) transforming the data into parallax camera coordinate system data 14-2. FIG. 9B illustrates the models 1 and 2 in the reference camera coordinate system with its origin at the reference camera RC while FIG. 9C the models 1 and 2 in the parallax camera coordinate system with its origin at a parallax camera R′C that is at a parallax angle θ relative to the line of sight of the reference camera RC.

While only one parallax camera, the parallax camera R′C, is shown in FIG. 9C for simplicity of description, at least two parallax cameras are required that form the predetermined parallax angle θ in the directions of left and right eyes relative to the reference camera RC.

FIG. 9D illustrates a relation between the reference camera coordinate system and the parallax camera coordinate system.

Next, the parallax camera coordinate system data 14-2 is subjected to perspective projection transform (processing step P4), as a result of which projection coordinate system data 14-3 or a 2D screen coordinate system is obtained.

Then, the projection coordinate system data 14-3 is output to the rendering unit 15 that draws parallax image data in the video memory 16.

In the above description, the feature of the present invention differs from that of the method for generating image data described in cited Document 1 in that the parallax camera coordinate system data 14-2 is obtained by conversion from the reference camera coordinate system data 14-1 before the reference camera coordinate system data 14-1 is subjected to perspective projection transform (processing step P3).

Further, during conversion to the parallax camera coordinate system data (processing step P3), processing is performed in correspondence with the principles of the present invention shown in FIGS. 3 to 5; switching between the parallax camera coordinate system data and the reference camera coordinate system data such that the image formation positions of the objects fall within the stereoscopic viewable range of the stereoscopic display device 18 (refer to FIGS. 3A through 3F), scaling of the parallax camera coordinate system data (refer to FIGS. 4A through 4C) and setting of a small parallax angle (refer to FIGS. 5A through 5F).

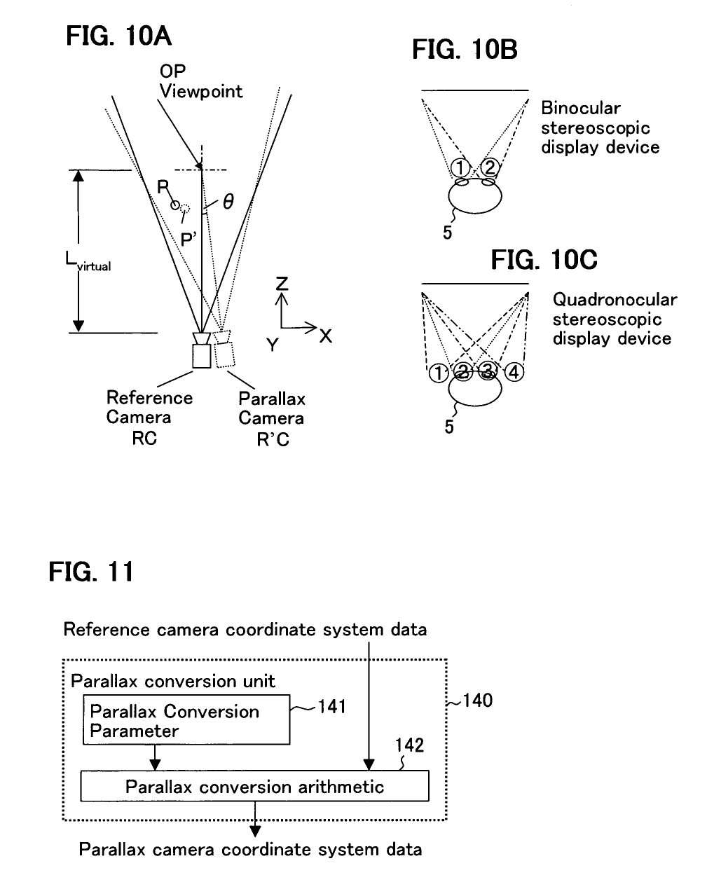

A method will now be described below with reference to FIGS. 10A through 10C for converting the reference camera coordinate system data 14-1 to the parallax camera coordinate system data 14-2.

As shown in FIG. 10A, if coordinate origins are at the reference camera RC, an object having coordinates P (x, y, z) is seen as located at coordinates P′ (x′, y′, z′) when we let the distance to the viewpoint OP (point where the line of sight from the parallax camera R′C intersects with that from the reference camera RC) be Lᵥᵢᵣₜᵤₐₗ and the parallax angle relative to the reference camera RC be θ.

At this time, the following relationship holds:

x′=x cosθ+z(−sinθ)+Lᵥᵢᵣₜᵤₐₗ sinθ Equation 1

y′=y Equation 1

z′=x sinθ+z cosθ+Lᵥᵢᵣₜᵤₐₗ(1−cosθ)

Here, the parallax camera R′C position can be approximated as shown below if the parallax camera R′C is assumed to be on the X axis that includes a position coordinate of the reference camera RC as shown in FIG. 9D and if the variation along the Z axis due to parallax is ignored.

x′=x cosθ−z sinθ+Lᵥᵢᵣₜᵤₐₗ sinθ Equation 2

y′≈y Equation 2

z′≈z

From the equation 2, the coordinates P (x, y, z) as seen from the reference camera RC can be approximately converted to the coordinates P′ (x′, y′, z′) as seen from the parallax camera R′C using a parameter (Lᵥᵢᵣₜᵤₐₗ, θ).

By subjecting polygon vertices of all model data to this conversion, a scene as seen from the reference camera RC can be approximately converted to a scene as seen from the parallax camera SC (the conversion and the parameter used are hereafter referred respectively to as parallax conversion and parallax parameter).

By setting a parameter (1) (Lᵥᵢᵣₜᵤₐₗ, −θ) as the parallax parameter for left eye and a parameter (2) (Lᵥᵢᵣₜᵤₐₗ, θ) as the parallax parameter for right eye, binocular parallax images can be generated for a binocular stereoscopic display device as shown in FIG. 10B. In the case of quadranocular images, the parameter set consists of (1) (Lᵥᵢᵣₜᵤₐₗ, −3θ), (2) (Lᵥᵢᵣₜᵤₐₗ, −θ) , (3) (Lᵥᵢᵣₜᵤₐₗ, θ) and (4) (Lᵥᵢᵣₜᵤₐₗ, 3θ) as shown in FIG. 10C. Similarly, expansion to multinocular images for an arbitrary number n of eyes is readily possible.

The parallax conversion is carried out by providing a parallax conversion unit 140 in the geometry unit 14 as shown in FIG. 11. That is, parallax conversion arithmetic 142 can be performed with parallax conversion parameter (Lᵥᵢᵣₜᵤₐₗ, nθ) 141 according to the equations 1 and 2 by inputting reference camera coordinate system data and by providing hardware or software.

As described above, the parallax camera coordinate system data P′ (x′, y′, z′), obtained by subjecting the reference camera coordinate system data P (x, y, z) to parallax conversion with the parallax conversion parameter P (Lᵥᵢᵣₜᵤₐₗ, θ), is expressed, from the equation 2, as shown below.

x′=x cosθ−z sinθ+Lᵥᵢᵣₜᵤₐₗ sinθ

y′=y

z′≈z

Therefore, performing the conversion on only the x component and substituting A=cosθ, B=−sinθ and C=Lᵥᵢᵣₜᵤₐₗ sinθ into the parallax conversion parameter P (Lᵥᵢᵣₜᵤₐₗ, θ) for further reduction in arithmetic cost yields:

x′=Ax+Bz+C

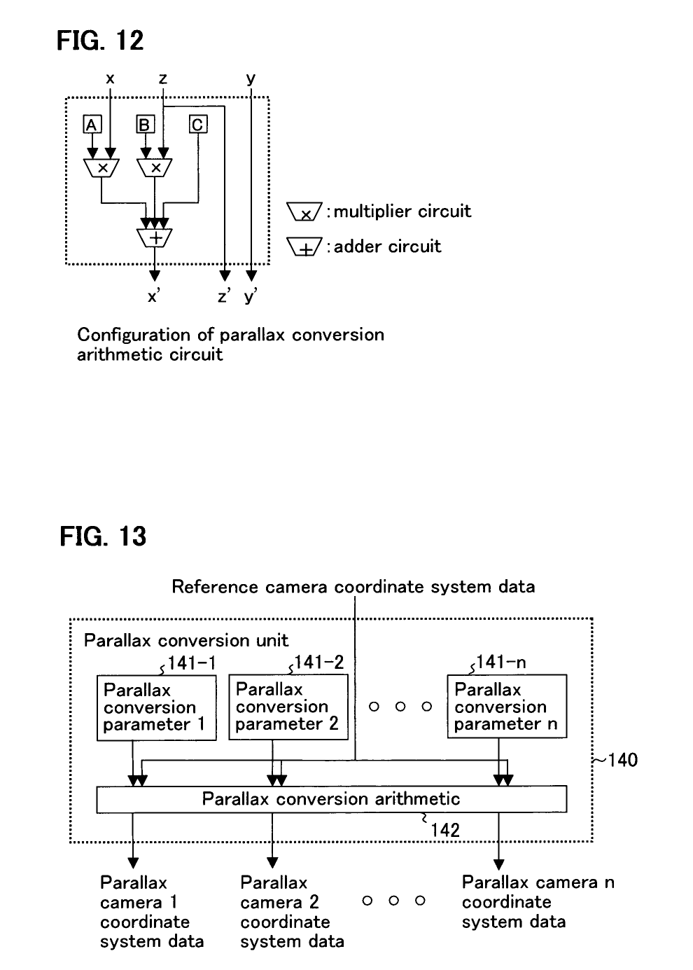

By exploiting the above-described advantage, the parallax conversion unit 140 shown in FIG. 11 can be configured with an operator having a simple configuration as shown in FIG. 12.

Further review reveals that storing parallax parameters 141-1 to 141-n for n number of eyes in the parallax conversion unit 140 as shown in FIG. 13 allows for conversion of a single piece of reference camera coordinate system data to parallax camera coordinate system data for n the number of eyes, thus speeding up processing since model data readout (processing step P1 in FIG. 8) and coordinate conversion in the geometry unit 14 (processing step P2 in FIG. 8) can be performed in parallel and in one operation.

A method will be described next for determining a parallax parameter used for the solution principle shown in FIG. 4.

A general equation of perspective projection transform (x, y, z)→(Sx, Sy) for converting 3D coordinates to 2D screen coordinates is expressed as follows:

Sx=F×x/z+Ch

Sy=F×y/z+Cv

(where F: focus value, Ch: horizontal center value, Cv: vertical center value)

If we let corresponding points, converted using the parallax conversion parameters (Lᵥᵢᵣₜᵤₐₗ, θ) and (Lᵥᵢᵣₜᵤₐₗ, −θ) and provided with parallax by the parallax cameras CR and CL for right and left eyes, be (x_{R}, y, z) and (x_{L}, y, z) , the difference in displacement D on the display screen of a stereoscopic display device 19 is as follows:

$$\begin{matrix}D = \vert {S}_{XR} - {S}_{XL} \vert \\ = \vert {F}_{XR} / z + Ch - ( {F}_{XL} / z + Ch ) \vert \\ = \vert F ( x cos θ - z sin θ + {L}_{virtual} sin θ ) / z - \\ F \{ x cos ( - θ ) - z sin ( - θ ) + {L}_{virtual} sin ( - θ ) \} / z \vert \\ = \vert F ( x cos θ - z sin θ + {L}_{virtual} sin θ ) / z - \\ F \{ x cos θ + z sin θ - {L}_{virtual} sin θ ) / z \vert \\ = \vert 2 F sin θ ( {L}_{virtual} - z ) / z \vert \\ = \vert 2 F sin θ ( {L}_{virtual} / z - 1 ) \vert\end{matrix} \qquad Equation 3$$

For the range of z>0,

$$\begin{matrix}( i ) 0 < z < {L}_{virtual} & : & D = 2 F sin θ ( {L}_{virtual} - z ) / z \\ ( ii ) z = {L}_{virtual} & : & D = 0 \\ ( iii ) {L}_{virtual} < z & : & D = 2 F sin θ ( z - {L}_{virtual} ) / z\end{matrix} \} Equation 3$$

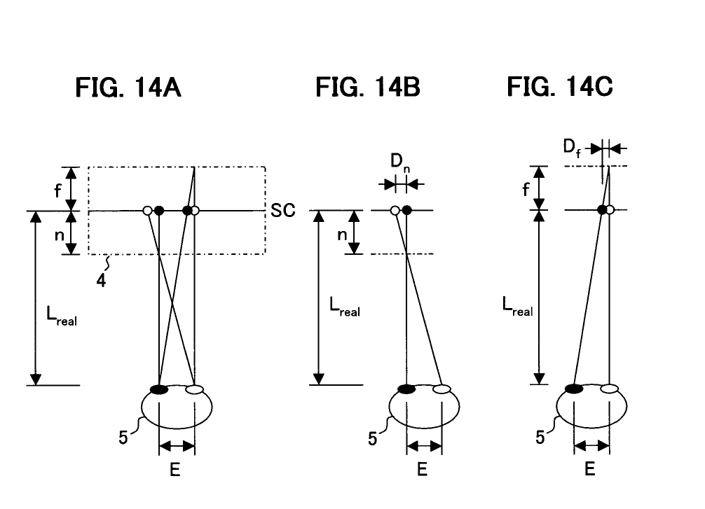

Next, if the distance Lᵥᵢᵣₜᵤₐₗ from the observer 5 to the image display screen SC and the eye-to-eye distance E of the observer 5 in a real space are fixed as shown in FIG. 14, the distance from the image display screen SC to the object image formation position is determined by the difference in displacement D due to object parallax. That is, it is only necessary to set the difference in displacement D due to parallax such that the image formation position falls within the stereoscopic viewable range 4.

If we let the distance from the observer 5 to the display surface SC be Lreal, the eye-to-eye distance of the observer 5 be E, the distance from the display surface SC to the forward stereoscopic viewable range 4 be n, the distance from the display surface SC to the backward stereoscopic viewable range 4 be f, the difference in displacement between corresponding points due to parallax be D, the difference in displacement due to parallax that gives forward stereoscopic viewable image formation limit be Dₙ and the difference in displacement due to parallax that gives backward stereoscopic viewable image formation limit be D_{f}, the forward merging limit that occurs when D=Dₙ is as follows from the triangle similarity relationship:

Dₙ/n=E/(Lᵣₑₐₗ−n)

Dₙ=E×n/(Lᵣₑₐₗ−n)

From equation 3 (i) , the following relationship holds between θ and z:

2F sinθ(Lᵥᵢᵣₜᵤₐₗ−z)/z=E×n/(Lᵣₑₐₗ−n)

sinθ(Lᵥᵢᵣₜᵤₐₗ−z)/z=E×n/[2F(Lᵣₑₐₗ−n)]

If we let the forward limit of the target display region in a 3D coordinate space be the forward clipping surface or z=cₙ, then θ=θₙₑₐᵣ that satisfies the following is an angle necessary for merging the forwardmost displayed object:

sinθ(Lᵥᵢᵣₜᵤₐₗ−cₙ)/cₙ=E×n/[2F(Lᵣₑₐₗ−n)]

sinθ=E×n×cₙ/[2F(Lᵣₑₐₗ−n)(Lᵥᵢᵣₜᵤₐₗ−cₙ)]

On the other hand, the backward merging limit that occurs when D=D_{f} is as follows from the triangle similarity relationship:

D_{f}/f=E/(Lᵣₑₐₗ+f)

Dₙ=E×f/(Lᵣₑₐₗ+f)

From equation 3(iii), the following relationship holds between θ and z:

2F sinθ(z−Lᵥᵢᵣₜᵤₐₗ)/z=E×f/(Lᵣₑₐₗ+f)

sinθ(z−Lᵥᵢᵣₜᵤₐₗ)/z=E×f/[2F(Lᵣₑₐₗ+f)]

If we let the backward limit of the target display region in a 3D coordinate space be the backward clipping surface or z=c_{f}, then θ=θ_{far} that satisfies the following is an angle necessary for merging the backwardmost displayed object:

sinθ(c_{f}−Lᵥᵢᵣₜᵤₐₗ)/c_{f=E×f/[}2F(Lᵣₑₐₗ+f)

sinθ=E×f×c_{f}/[2F(Lᵣₑₐₗ+f)(c_{f}−Lᵥᵢᵣₜᵤₐₗ)]

Hence, a parameter θ that allows merging of all objects for cₙ≦z≦c_{f} is

θ=min[θₙₑₐᵣ, θ_{far}]

When θₙₑₐᵣ=θ_{far}, the following relationship holds:

F(Lᵣₑₐₗ−n)/[n(Lᵣₑₐₗ+f)]=cₙ(c_{f}−Lᵥᵢᵣₜᵤₐₗ)/[c_{f}(Lᵥᵢᵣₜᵤₐₗ−cₙ)

Also, when Dₙ=D_{f}, the following relationship holds:

(Lᵣₑₐₗ−n)/n=(Lᵣₑₐₗ+f)/f

L/2x(1/n−1/f)=1

Therefore, when θₙₑₐᵣ=θ_{far} and Dₙ=D_{f}

cₙ(c_{f}−Lᵥᵢᵣₜᵤₐₗ)/c_{f}(Lᵥᵢᵣₜᵤₐₗ−cₙ)]=1

Lᵥᵢᵣₜᵤₐₗ=2cₙc_{f}/(cₙ+c_{f})

At this time,

sinθₙₑₐᵣ=sinθ_{far}=E×f×(cₙ+c_{f})/[2F(Lᵣₑₐₗ+f)(c_{f}−cₙ)]

Incidentally, if we let Lᵥᵢᵣₜᵤₐₗ=Lᵣₑₐₗ, cₙ=L−n and c_{f}=L+f, then sinθₙₑₐᵣ=sinθ_{far}=E/(2F) results.

The parallax parameter θ can be found as described above. Note that Lvirtual can be found from the gazing point (point of intersection of lines of sight of the parallax cameras) and the distance to the reference camera. Although, in the above description, use of hardware was mainly discussed for acquisition of parallax camera coordinate data from reference camera coordinate data, software may be used, if attention is focused on the feature of the present invention for displaying stereoscopic and planar images in a mixture, to directly obtain parallax camera coordinate data for left and right eyes without being based on reference camera coordinate data.

Physiological factors for stereoscopic perception are different between the observers 5. Further, the degree of stereoscopic perception varies depending on the image displayed during game playing. Therefore, the gaming apparatus shown in FIG. 6 is provided with the parallax adjustment unit 103 in correspondence therewith.

That is, the player can change parallax angle data properly in real time by operating the parallax adjustment unit 103 during parallax conversion (processing step P3) even when the game is in progress.

In this case, it is possible for the observer to perceive three-dimensionality suited for him or her. In particular, if the gaming apparatus is installed in an environment such as a game center where an indefinite number of people can become players, it is preferred that the parallax adjustment unit 103 be provided such that the parallax angle can be adjusted suitably for physiological factors of each player, instead of automatically using the same parallax angle. It is further preferred that the parallax angle be changed gradually from weaker to stronger three-dimensionality or continuously.

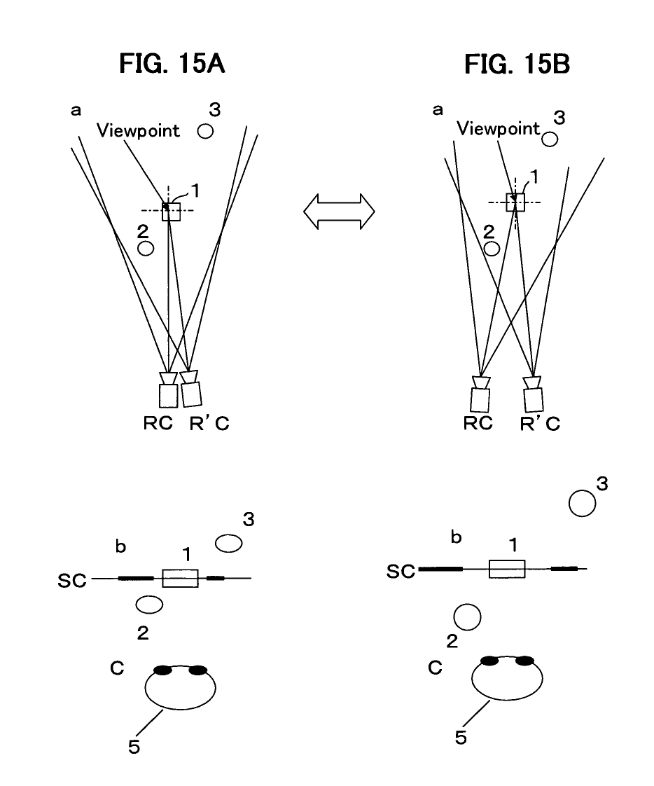

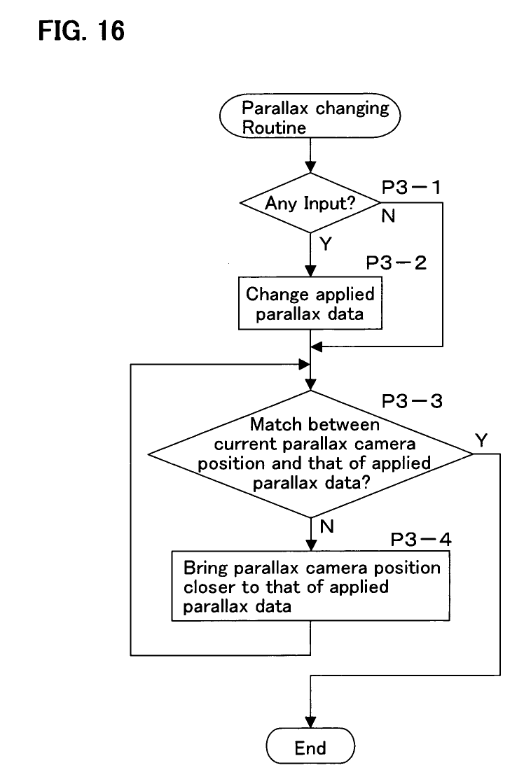

FIGS. 15A and 15B illustrate explanatory drawings describing changing of applied parallax data by the parallax adjustment unit 103 while FIG. 16 illustrates an example of processing operations corresponding to FIG. 15. FIG. 15A illustrates a case in which the space between the reference camera RC and the parallax camera R′C is narrow while FIG. 15B a case in which the space between the reference camera RC and the parallax camera R′C is wide.

When the CPU 12 detects a parallax change input from the parallax adjustment unit 103 (FIG. 16: Yes answered in processing step P3-1), the CPU 12 changes applied parallax data such as distance between parallax cameras (processing step P3-2). The CPU 12 continuously and gradually brings the parallax camera position closer to the camera position corresponding to the applied parallax data until the current parallax camera position matches that based on the applied parallax data (processing steps P3-3, P3-4).

It is important to gradually bring the parallax camera position closer to the camera position corresponding to the applied parallax data for maintaining binocular fusion (state in which the observer is capable of stereoscopic vision) particularly if the space between parallax cameras is increased. That is, since instantaneous transition from weak to strong parallax states is likely to throw binocular fusion off balance, gradually expanding the space between parallax cameras prevents such an inconvenience.

In FIG. 15, the parallax camera R′C position is adjusted from FIG. 15A to FIG. 15B or vice versa. With the position shown in FIG. 15A, the objects 2 and 3 are close to the stereoscopic display surface SC (FIG. 15A, b) , making stereoscopic vision easier but resulting in an image poor in three-dimensionality. With the position shown in FIG. 15B, on the other hand, the objects 2 and 3 are far from the stereoscopic display surface SC (FIG. 15A, b), making stereoscopic vision more difficult but providing an image rich in three-dimensionality.

Thus, by using parallax adjustment unit 103, it is possible to gradually switch from a state in which stereoscopic vision is easy to achieve by the observer to an observation state rich in three-dimensionality while at the same time maintaining binocular fusion.

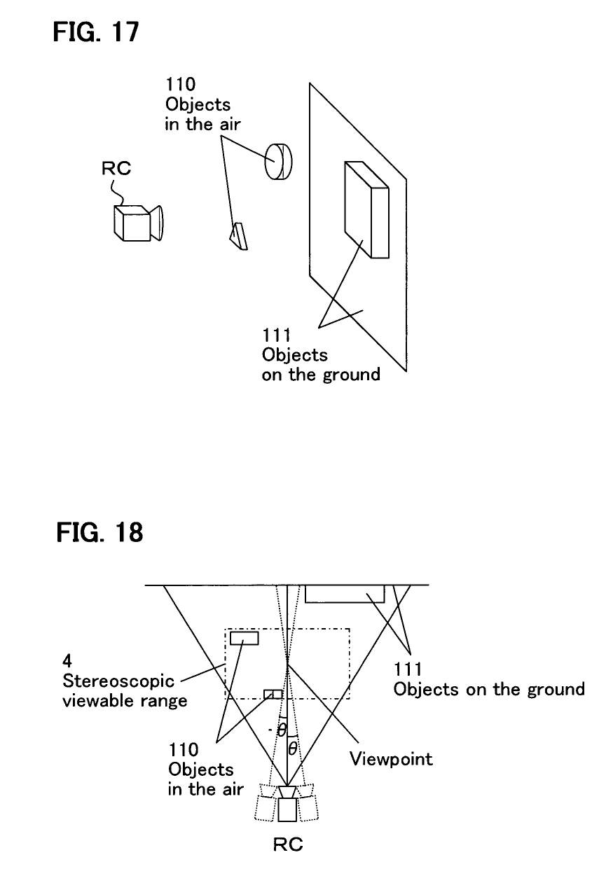

Next, FIG. 17 illustrates, as a working example, a scene viewed from the camera RC in the sky in which, of objects, only objects in the air 110 are viewed stereoscopically while an object on the ground 111 is viewed planarly.

The example in FIG. 17 shows a state in which only the objects in the air 110 are located within the stereoscopic viewable range 4, with the object on the ground 111 located outside the stereoscopic viewable range 4, as shown in the corresponding plan view shown in FIG. 18.

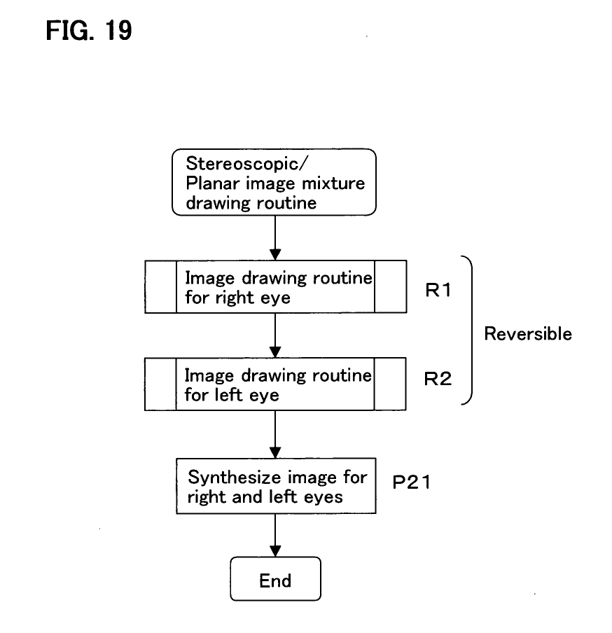

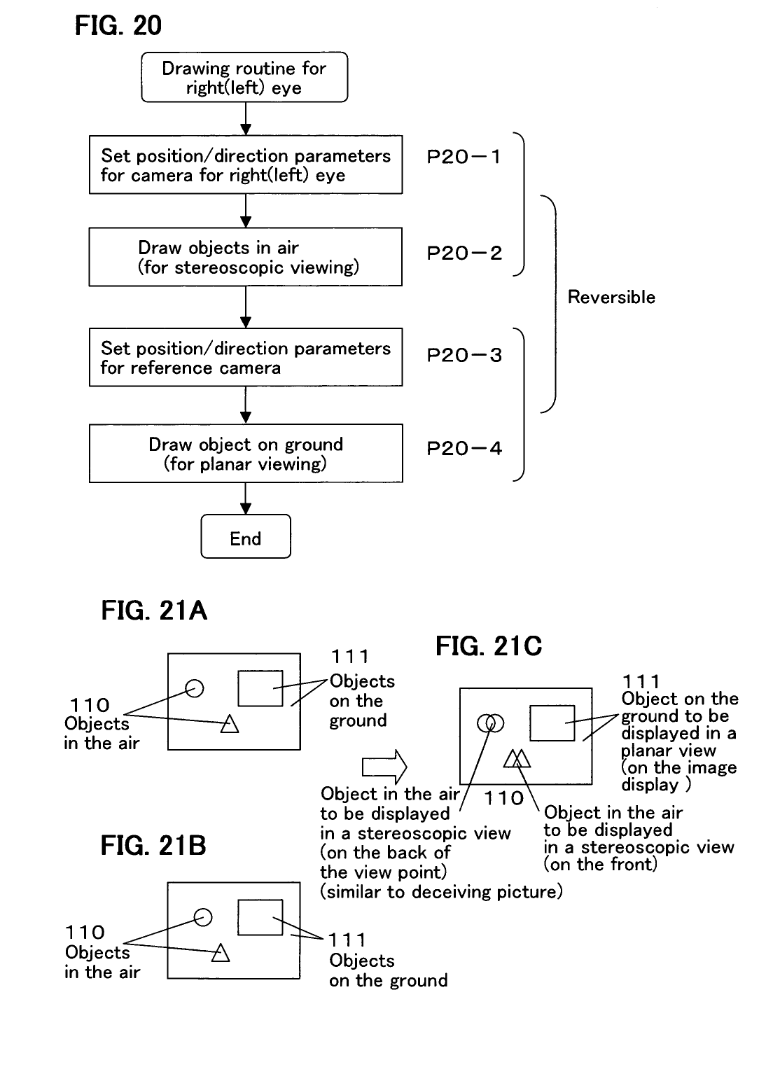

FIGS. 19 and 20 illustrate flowcharts showing processing procedures corresponding to the example shown in FIG. 17. The objects in the air 110 and the object on the ground 111 are assumed to be distinguishable from each other by the programmer in advance. As for the objects in the air 110, the parallax parameters of the parallax cameras for right and left eyes are respectively set to (Lᵥᵢᵣₜᵤₐₗ, θ) and (Lᵥᵢᵣₜᵤₐₗ, −θ) relative to the direction of line of sight of the reference camera. As for the object on the ground 111, the parallax parameters of the parallax cameras for right and left eyes are both set to (Lᵥᵢᵣₜᵤₐₗ, 0), that is, brought into agreement with that of the reference camera before a drawing command is issued.

In response to the drawing command, an image drawing routine for right eye R1 and an image drawing routine for left eye R2 are executed according to a stereoscopic/planar image mixture drawing routine flow shown in FIG. 19. The drawing routines R1 and R2 are executed according to a flow shown in FIG. 20, and the sequence of their execution can be changed.

In the drawing routine flow for right (left) eye shown in FIG. 20, the position/direction parameters—parallax parameters (Lᵥᵢᵣₜᵤₐₗ, θ) and (Lᵥᵢᵣₜᵤₐₗ, −θ)—are set for the objects in the air 110 (processing step P20-1), and the objects in the air 110 are drawn in the video memory 16 by the processing performed by the geometry unit 14 and the rendering unit 15 described in FIG. 8 (processing step P20-2).

Further, in the drawing routine flow shown in FIG. 20, the position/direction parameter (Lᵥᵢᵣₜᵤₐₗ, 0) is set as the parameter for left (right) eye for the object on the ground 111 in the same scene (processing step P20-3) and the object on the ground 111 is drawn in the video memory 16 by the processing performed by the geometry unit 14 and the rendering unit 15 described in FIG. 8 (processing step P20-3)

Note that it is possible to reverse the sequence of the steps—parameter settings for the objects in the air 110 and the object on the ground 111 and drawing of the objects.

FIGS. 21A and 21B illustrate drawn images for right and left eyes drawn in the video memory 16 by the above drawing routine flows R1 and R2.

Next, the drawn images of the objects in the air 110 and the object on the ground 111 for right eye (FIG. 21A) and those for left eye (FIG. 21B) drawn in the video memory 16 by the drawing routines R1 and R2 shown in FIG. 19 are synthesized and output to and displayed on the stereoscopic display device 18. This allows for the objects in the air 110 to be displayed in a stereoscopic view and the object on the ground 111 to be displayed in a planar view.

Note that since the image of the object on the ground 111 with no parallax is formed on the image display surface in FIG. 21C, the objects in the air 110 are required to be located to the front of the camera's viewpoint in order for the objects in the air 110 to be displayed to the front. Conversely, placing the objects in the air 110 to the back of the viewpoint produces an effect similar to deceiving picture—the effect that an object that should be on the front looks as through it is on the back.

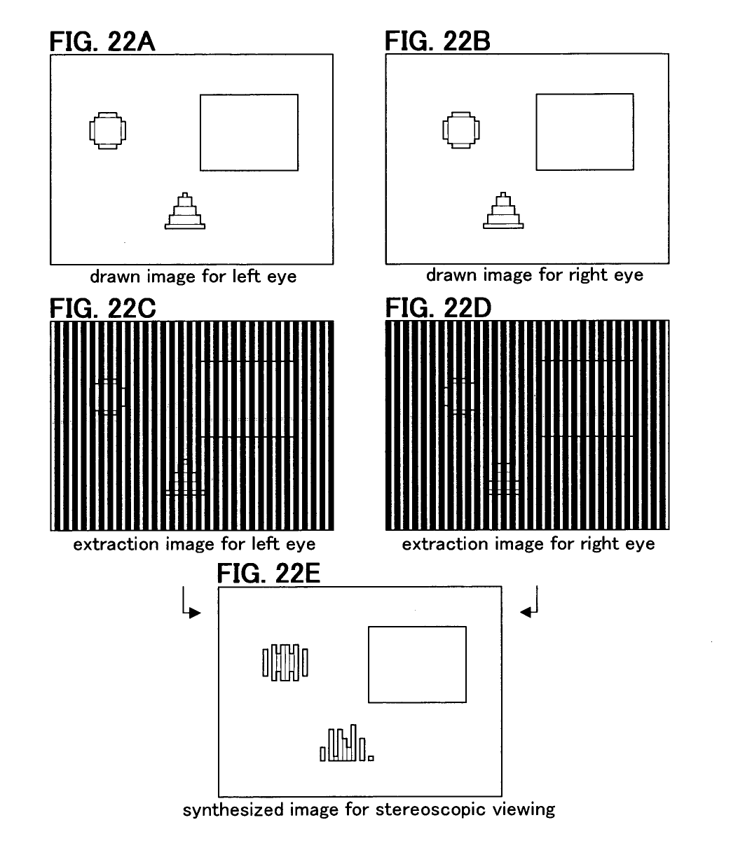

FIGS. 22 illustrate the process of displaying the drawn images for left and right eyes, described in FIGS. 17 to 21, on the stereoscopic display device 18.

FIGS. 22A and 22B illustrate the drawn images for left and right eyes drawn in the video memory based on the drawing data for the objects in the air 110 to be viewed stereoscopically and the object on the ground 111 to be viewed planarly that are shown respectively in FIGS. 21A and 21B as examples. That is, one of the images is the drawnimage for lefteye (FIG. 22A) resulting from drawing, in the video memory 16, the drawing data of the object on the ground 111 obtained from the reference camera RC and drawing the drawing data of the objects in the air 110 obtained from the parallax camera for left eye having a parallax angle relative to the reference camera RC while the other image is the drawn image for right eye (FIG. 22B) similarly resulting from drawing, in the video memory 16, the drawing data of the object on the ground 111 obtained from the reference camera RC and drawing the drawing data of the objects in the air 110 obtained from the parallax camera for right eye having a parallax angle relative to the reference camera RC.

These drawn images for left and right eyes are tailored to suit the stereoscopic display device to be used. FIGS. 22C and 22D illustrate examples in which the barrier system is used for the drawn image for left eye (FIG. 22A) and the drawn image for right eye (FIG. 22B). In these examples, a barrier in slit form is formed for each image. In the case of FIG. 22C, the image is tailored such that the slit barrier range cannot be observed with right eye while, in the case of FIG. 22D, the image is tailored such that the slit barrier range cannot be observed with left eye.

Next, the images shown in FIGS. 22C and 22D are synthesized by placing the images one upon another, thus generating a synthesized image for stereoscopic viewing as shown in FIG. 22E. By displaying the image on the stereoscopic display device and observing the image with both eyes, it is possible to simultaneously display the objects in the air 110 in a stereoscopic view and the object on the ground 111 in a planar view on a single screen. The synthesis conducted here means tailoring of the images such that the image for right eye can be observed only by right eye and that the image for left eye only by left eye. This technique is applicable to the head mount display system in which images for left and right eyes can be independently displayed respectively for corresponding eyes, to the system in which images for left and right eyes are alternately displayed using shutter type glasses and further to multinocular stereoscopic display devices.

As described above with reference to the drawings, it is possible, according to the present invention, to provide the method and apparatus for generating stereoscopic images that can efficiently generate stereoscopic images that do not burden the observer's eyes.

While illustrative and presently preferred embodiments of the present invention have been described in detail herein, it is to be understood that the inventive concepts may be otherwise variously embodied and employed and that the appended claims are intended to be construed to include such variations except insofar as limited by the prior art.

What is claimed is:

1. A method for generating stereoscopic images, comprising the steps of:
converting, of objects made of polygons having 3D coordinates, object data to be displayed in a planar view to reference camera coordinate system data with its origin at a reference camera and converting object data to be displayed in a stereoscopic view to parallax camera coordinate system data for right and left eyes respectively with their origins at parallax cameras for right and left eyes having predetermined parallax angles;
drawing the reference camera coordinate system object data and the parallax camera coordinate system object data for right eye as image data for right eye in a video memory;
drawing the reference camera coordinate system object data and the parallax camera coordinate system object data for left eye as image data for left eye in the video memory; and
synthesizing the image data for right and left eyes drawn in the video memory and displaying, on a stereoscopic display device, images mixing stereoscopic and planar objects.

2. The method for generating stereoscopic images according to claim 1, wherein the objects to be displayed in a planar view are objects having their image formation positions outside a stereoscopic viewable range of the stereoscopic display device in a 3D coordinate space.

3. A method for generating stereoscopic images, comprising the steps of:
converting object data made of polygons having 3D coordinates to parallax camera coordinate system data respectively with their origins at parallax cameras for right and left eyes having predetermined parallax angles;
performing scaling using the converted parallax camera coordinate system data to compress coordinates of the parallax camera coordinate system data in the direction of the depth of a stereoscopic viewable range of a stereoscopic display device such that all the objects have their image formation positions within the stereoscopic viewable range;
drawing the scaled parallax camera coordinate system data in a video memory; and
displaying, on the stereoscopic display device, drawing data drawn in the video memory.

4. A method for generating stereoscopic images, comprising the steps of:
converting object data made of polygons having 3D coordinates to parallax camera coordinate system data respectively with their origins at parallax cameras for right and left eyes having parallax angles;
narrowing the parallax angles during conversion to the parallax camera coordinate system data such that all objects of the parallax camera coordinate system data to be converted have their image formation positions within a stereoscopic viewable range of a stereoscopic display device; and
displaying, on the stereoscopic display device, the converted parallax camera coordinate system data at the narrowed parallax angles.

5. A method for generating stereoscopic images, comprising the steps of:
converting object data made of polygons having 3D coordinates to reference camera coordinate system data with its origin at a reference camera;
converting, of object data converted to the reference camera coordinate system data, object data to be displayed in a stereoscopic view to parallax camera coordinate system object data respectively with their origins at parallax cameras for right and left eyes having predetermined parallax angles;
drawing the reference camera coordinate system object data and the parallax camera coordinate system object data for right eye as image data for right eye in a video memory;
drawing the reference camera coordinate system object data and the parallax camera coordinate system object data for left eye as image data for left eye in the video memory; and
synthesizing the image data for right and left eyes drawn in the video memory and displaying, on a stereoscopic display device, images mixing stereoscopic and planar objects.

6. The method for generating stereoscopic images according to claim 5, wherein the objects to be displayed in a planar view are objects having their image formation positions outside a stereoscopic viewable range of the stereoscopic display device in a 3D coordinate space.

7. A method for generating stereoscopic images, comprising the steps of:
converting object data made of polygons having 3D coordinates to reference camera coordinate system data with its origin at a reference camera;
generating, from the reference camera coordinate system data, parallax camera coordinate system data respectively with their origins at parallax cameras for right and left eyes having parallax angles;
performing compression scaling during generation of the parallax camera coordinate system data such that all objects have their image formation positions within a stereoscopic viewable range of a stereoscopic display device;
drawing the parallax camera coordinate system data for right and left eyes in a video memory; and
synthesizing the image data for right and left eyes drawn in the video memory and displaying the data on the stereoscopic display device.

8. A method for generating stereoscopic images, comprising the steps of:
converting object data made of polygons having 3D coordinates to reference camera coordinate system data with its origin at a reference camera;
converting the reference camera coordinate system data to parallax camera coordinate system data respectively with their origins at parallax cameras for right and left eyes having parallax angles;
narrowing the parallax angles during conversion to the parallax camera coordinate system data such that all objects of the parallax camera coordinate system data to be converted have their image formation positions within a stereoscopic viewable range of a stereoscopic display device; and
displaying, on the stereoscopic display device, the converted parallax camera coordinate system data at the narrowed parallax angles.

9. The method for generating stereoscopic images according to any one of claim 1, wherein the parallax angles of the parallax cameras are adjustable in real time by operations of an observer.

10. The method for generating stereoscopic images according to claim 9, wherein the parallax angles are continuously and gradually varied as a result of the adjustment by operations of the observer.

11. An apparatus for generating stereoscopic images, comprising:
a geometry unit for converting object data made of polygons having 3D coordinates to reference camera coordinate system data with its origin at a reference camera and converting, of objects converted to the reference camera coordinate system data, object data to be displayed in a stereoscopic view to parallax camera coordinate system data respectively with their origins at parallax cameras for right and left eyes having predetermined parallax angles;
a video memory for drawing the reference camera coordinate system object data and the parallax camera coordinate system object data for right eye as image data for right eye and further drawing the reference camera coordinate system object data and the parallax camera coordinate system object data for left eye as image data for left eye; and
a rendering unit for synthesizing the image data for right and left eyes drawn in the video memory, wherein a stereoscopic display device is provided that displays images mixing stereoscopic and planar objects using image data for right and left eyes synthesized by the rendering unit.

12. An apparatus for generating stereoscopic images, comprising:
a geometry unit for converting object data made of polygons having 3D coordinates to reference camera coordinate system data with its origin at a reference camera and generating, from the reference camera coordinate system data, parallax camera coordinate system data respectively with their origins at parallax cameras for right and left eyes having parallax angles; and
a stereoscopic display device for displaying an image made by synthesizing images for right and left eyes generated from the parallax camera coordinate system data for right and left eyes, wherein
the parallax camera coordinate system data is scaled during generation of the parallax camera coordinate system data from the reference camera coordinate system data by the geometry unit such that all objects have their image formation positions within a stereoscopic viewable range of the stereoscopic display device.

13. An apparatus for generating stereoscopic images, comprising:
a geometry unit for converting object data made of polygons having 3D coordinates to reference camera coordinate system data with its origin at a reference camera and generating, from the reference camera coordinate system data, parallax camera coordinate system data respectively with their origins at parallax cameras for right and left eyes having parallax angles; and
a stereoscopic display device for displaying an image made by synthesizing images for right and left eyes generated from the parallax camera coordinate system data for right and left eyes, wherein
the parallax angles are set during generation of the parallax camera coordinate system data from the reference camera coordinate system data by the geometry unit such that all objects have their image formation positions within a stereoscopic viewable range of the stereoscopic display device.

14. The apparatus for generating stereoscopic images according to any one of claim 11, wherein an input unit is further provided, and wherein the camera parallax angles are adjusted in real time by the geometry unit according to a parallax adjustment signal input from the input unit in correspondence with operations of the observer.

15. The apparatus for generating stereoscopic images according to claim 14, wherein the parallax angles are continuously and gradually varied as a result of the parallax angle adjustment.

16. A storage medium for storing a program run in an apparatus for generating stereoscopic images, the apparatus being provided with a geometry unit for converting coordinates of object data made of polygons having 3D coordinates and with a stereoscopic display device for displaying model data that has been subjected to the coordinate conversion, the program including the steps of:
allowing the geometry unit to convert, of the objects, object data to be displayed in a planar view to reference camera coordinate system data with its origin at a reference camera and convert object data to be displayed in a stereoscopic view to parallax camera coordinate system data respectively with their origins at parallax cameras for right and left eyes having predetermined parallax angles;
drawing the reference camera coordinate system object data and the parallax camera coordinate system object data for right eye as image data for right eye in a video memory;
drawing the reference camera coordinate system object data and the parallax camera coordinate system object data for left eye as image data for left eye in the video memory; and
synthesizing the image data for right and left eyes drawn in the video memory and displaying, on a stereoscopic display device, images mixing stereoscopic and planar objects.

17. The storage medium for storing a program according to claim 16, wherein the objects tobe displayed in aplanar view are objects having their image formation positions outside a stereoscopic viewable range of the stereoscopic display device in a 3D coordinate space.

18. A storage medium for storing a program run in an apparatus for generating stereoscopic images, the apparatus being provided with a geometry unit for converting coordinates of object data made of polygons having 3D coordinates and with a stereoscopic display device for displaying model data that has been subjected to the coordinate conversion, the program including the steps of:
allowing the geometry unit to convert the object data to parallax camera coordinate system data respectively with their origins at parallax cameras for right and left eyes having predetermined parallax angles;
performing compression scaling of the converted parallax camera coordinate system data in the direction of the depth of a stereoscopic viewable range of the stereoscopic display device such that all the objects have their image formation positions within the stereoscopic viewable range;
drawing the objects that have been subjected to compression scaling as image data for right and left eyes in a video memory; and
synthesizing the image data drawn in the video memory and displaying the data in a mixture on the stereoscopic display device.

19. A storage medium for storing a program run in an apparatus for generating stereoscopic images, the apparatus being provided with a geometry unit for converting coordinates of object data made of polygons having 3D coordinates and with a stereoscopic display device for displaying model data that has been subjected to the coordinate conversion, the program including the steps of:
allowing the geometry unit to convert the object data to parallax camera coordinate system data respectively with their origins at parallax cameras for right and left eyes having parallax angles;
narrowing the parallax angles such that all objects of the parallax camera coordinate system data to be converted have their image formation positions within a stereoscopic viewable range of the stereoscopic display device; and
displaying, on the stereoscopic display device, the converted parallax camera coordinate system data at the narrowed parallax angles.

20. The storage medium for storing a program according to any one of claim 16, wherein the parallax angles of the parallax cameras are adjustable in real time by operations of an observer.

21. The storage medium for storing a program according to claim 20, wherein the parallax angles are continuously and gradually varied as a result of the adjustment by operations of the observer.
